(19) United States
(12) Patent Application Publication
(10) Pub. No.: US 2022/0407877 A1
(43) Pub. Date: Dec. 22, 2022

(54) DETECTING DATA LEAKAGE

(71) Applicant: International Business Machines Corporation, Armonk, NY (US)

(72) Inventors: Sean Cawood, Eastleigh (GB); Simon Francis Page, Southampton (GB)

(21) Appl. No.: 17/352,430

(22) Filed: Jun. 21, 2021

(51) Int. Cl. H04L 29/06

(52) U.S. Cl. CPC H04L 63/1425; H04L 63/1433; H04L 63/145; H04L 63/083

(57) ABSTRACT

Detecting a data leak by detecting user input in a first form, the user input satisfying a set of requirements, storing the user input in a memory, generating a synthetic input satisfying the set of requirements, transmitting a second form including the synthetic input, searching resources for the synthetic input, determining if the synthetic input is present among the resources according to the search, and acting upon the determination.

### FIELD OF THE INVENTION

The disclosure relates generally to the detection of local data leakages. The disclosure relates particularly to the detection of local password data leakages.

### BACKGROUND

Computer system data, including user password data, may be compromised at a local level by malicious software. Such software captures the data and provides the captured data to a malicious actor. Submission of data over network resources represents an additional exposure of the data. Such an exposure may also lead to capture of the data by malicious code monitoring the network data transfers.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable detecting data leaks.

Aspects of the invention disclose methods, systems and computer readable media associated with detecting a data leak by detecting user input in a first form, the user input satisfying a set of requirements, storing the user input in a memory, generating a synthetic input satisfying the set of requirements, transmitting a second form including the synthetic input, searching resources for the synthetic input, determining if the synthetic input is present among the resources according to the search, and acting upon the determination.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

FIG. 3 depicts a cloud computing environment, according to an embodiment of the invention.

FIG. 4 depicts abstraction model layers, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

Multiple ways exist for passwords to be compromised from a local system where the password was divulged. Many existing approaches to preventing password leakage, prevent passwords being compromised ‘on the wire’ while they are being transferred to a remote party in a man-in-the-middle attack, but do not ensure that the location it is being sent to is valid, and that the password has not been compromised on the local system. Existing approaches to prevent local attacks, include detecting malicious code running through program signatures and detecting known bad behavior. Disclosed embodiments enable data leak detection in a more targeted way, reducing the need to detect signatures of programs themselves. Instead, disclosed embodiments detect the specific behavior related to the compromising of sensitive data.

Aspects of the present invention relate generally to detecting data leaks in a networked computing environment. Such environments include multiple computer systems connected by one or more network communications technologies. System users provide user password data to gain access to system resources. Compromised networks and system resources may capture the user password data and share such captured data with one or more malicious actors. Malicious software captures user password data as it is entered by a user, or as it is submitted across network resources, or received by networked resources. Such code stores the captured code for further transmission and use by the malicious actors. Disclosed embodiments enable detection of data leaks, including leaks associated with malicious software.

Embodiments detect the entry of password data by a user in completing a login form. Embodiments store the user data entry form and generate a synthetic replacement for the user data. The user data and the synthetic replacement each satisfy the requirements for the user password data. Embodiments transmit a second version of the data entry form, this version including the synthetic data rather than the actual sensitive user data. Concurrent with generating and submitting the synthetic data, the disclosed embodiments begin monitoring local and networked resources including network data traffic. Monitoring also includes scanning memory resources for variations including the synthetic data and commands to write the synthetic data to memory resources or to transmit the synthetic data over the communications channel(s). Embodiments compile detected efforts to leak the synthetic data into reports for the user and/or system administrators as well as issuing alerts to the user that transmitting the user password data is not secure. For instances where monitoring resources and transmissions fails to detect efforts to leak the data, the embodiments transmit the saved form including the actual sensitive user password data to facilitate authentication of the user enabling user access to the desired resources.

In accordance with aspects of the invention there is a method for automatically detecting data leaks. The method includes monitoring system activity to detect efforts by a user to submit sensitive data, such as password data, as a part of a network interaction. A user may complete an authentication form by inputting their user identification and password data. Methods detect the input form and the password data. Methods capture and save the completed authentication form locally. Methods generate synthetic password data and submit a second version of the authentication form, this version including the synthetic data. Methods monitor local memory resource and network resources, including network transmissions, for variations of the synthetic data. Detection of the synthetic data among local memory resources and/or network resources provides an indication of a potential data leak. Analysis of the detected data determines whether an effort to leak the data has occurred or that the detected data represents a normal data use. Leak occurrences are reported out to system users and administrators. Failure to detect unusual occurrences of the synthetic data provides an indication that no effort to leak the data has occurred. The system passes the saved form including the authenticate user password data for authentication of user access.

Aspects of the invention provide an improvement in the technical field of data leak detection by receiving authenticate user data, generating a synthetic set of data satisfying any data requirements and passing the synthetic data forward using normal communications channels. The method reserves the authenticate user data from disclosure at this point in the process timeline. Monitoring system activity reveals efforts to leak sensitive data without exposing actual sensitive data. Detected efforts are compiled and reported with disclosure of the authenticate data withheld pending resolution of compromised system aspects. Successful transmission of the synthetic data—transmission without accompanying detection of data leakage—results in transmission of the authenticate user data for authentication enabling user access.

Aspects of the invention also provide an improvement to computer functionality. In particular, implementations of the invention are directed to a specific improvement to the way data communications channels are verified as secure. Disclosed methods verify such channels by submitting data entry forms including synthetic data rather than actual sensitive data and monitoring system activities including memory write actions and data transmissions for evidence that the synthetic data has been mishandled or otherwise leaked. Detection of data mishandling leads to identifying compromised system aspects and resolution of these compromised aspects resulting in secure communications channels.

In an embodiment, one or more components of the system can employ hardware and/or software to solve problems that are highly technical in nature (e.g., detecting user input of sensitive information in a first form, generating synthetic information satisfying a set of requirements associated with the sensitive information, transmitting a second version of the form including the synthetic information but not the sensitive information, monitoring system and network activity for traces of the synthetic information, acting upon the results of the monitoring activities, etc.). These solutions are not abstract and cannot be performed as a set of mental acts by a human due to the processing capabilities needed to facilitate data leak detection, for example. Further, some of the processes performed may be performed by a specialized computer for carrying out defined tasks related to detecting leaks of sensitive data. For example, a specialized computer can be employed to carry out tasks related to data leak detection, or the like.

As an overview, embodiments detect the leakage of local passwords or other sensitive information by temporarily injecting a ‘searchable’ string into a field where this information is inputted. After submitting the injected input, a scan of local memory and outgoing network data packets would begin looking for the ‘searchable’ string that was injected. Methods generate a report and/or alert based on the findings of the scan and determine if any malicious attempts to siphon off sensitive information to third party servers, or third party applications, on the user's local machine have occurred. The user can take remedial action to remove or isolate the malicious software etc., according to the report.

Unlike existing methods, disclosed embodiments do not rely upon a known signature associated with a keylogger, or virus, or upon detecting known hooks attempting to connect to an operating system. Embodiments detect the leak of values wherein the leaked valuers constitute only non-sensitive synthetic data rather than sensitive user data. Data leaks may include writes to memory of the captured data and transmission of the captured data using network resources.

In an embodiment, a computer implemented method for detecting a data leak includes detecting user activities associated with inputting sensitive data, such as user personally identifying information, or user authentications data such as password and user identification data. Such user activities include completing one or more data entry forms with the sensitive data. In an embodiment, the method scans user activity for keywords such as “userid”, “password”, account number “social security number”, etc., as indicators that the user will be submitting sensitive data to an application.

As an example, the method detects the completion, by a user, of a user login form including data entry fields labeled “userid” and “password”, by inputting their user identification and user password data into the login data entry form. In this example, the user data conforms to field requirements associated with the user identification and user password. In this embodiment, the method detects the activity and captures the completed sensitive data entry form, including the user data, and stores the completed data entry form for later use. In an embodiment, the method stores the completed data entry form in local memory.

The method generates synthetic data corresponding to the sensitive user data and complying with any and all data field requirements. As an example, a user password must contain sixteen characters, including an upper-case character, lower-case character, numerical character, and special character. For this example, the method generates synthetic user password data complying with the user password requirements. In an embodiment, the method analyzes the character composition of the user input and generates one or more random character strings having the same composition in terms of number and type of characters in the sensitive user data string. For the example above, the analysis indicates that the user password includes sixteen characters including an upper-case character, lower-case character, numerical character, and special character. The method then generates a string of random characters having the characteristics found by the analysis. The method populates a blank copy of the data entry form (i.e., the login form) using the generated synthetic data based upon the characteristics of the sensitive user data. the method stores the values of the generated synthetic data for use in scanning resources for data leaks.

In an embodiment, the method begins monitoring local system memory use and network data transmissions as or after populating the data entry form with the synthetic data. The method monitors data packet contents as well as write commands and memory locations subject to write commands, evaluating data written to memory, prepared for transmission, and/or transmitted over one or more networks after monitoring starts as well as subsequent to populating and submitting the data entry form with the synthetic data.

In an embodiment, the method transmits the data entry form populated with the synthetic data using the standard communications channel(s) for the form such as transmission control protocol (TCP) data packet transmission, or other data communication protocols. In this embodiment, the method continues monitoring the memory operations and data prepared for outbound transmission over the network. The method scans for data leaks by monitoring memory write commands and outbound data packets for the synthetic data strings subsequent to transmitting the form with the synthetic data included.

The method scans system memory resources and network communication traffic until one of three things occurs. First, scanning stops after all relevant memory and communications resources have been scanned and no indication of a malicious use of the synthetic strings has been found. In such cases, the method then submits the original data entry form containing the sensitive data of the user such as to continue with the user's efforts to authenticate their access to network resources. Second, scanning stops after a defined time limit considered sufficient to detect malicious efforts to utilize the synthetic data generated by the method and transmitted using the substitute data entry version of the form. In such instance, the method again transmits the original data entry form containing the sensitive user information as the method has not detected a data leak. A third possibility includes detecting malicious use of the synthetic data string by detecting efforts to write the string to local memory or inclusion of the synthetic string in outbound communications packets. In such instances, the method retains the original data entry form and the sensitive information of the user rather than submitting the form as part of an authentication process. The sensitive data of the user remains secured by the system and methods. In an embodiment, the method issues an alert to a user and/or a system administrator informing them of the malicious attempt to capture the synthetic string and providing the details regarding any such attempts. In this embodiment, the method does not submit the original data entry form including the sensitive user data, thereby stopping the authentication process. In an embodiment, the method maintains an ongoing log of all such attempts together with the details of system resources involved in the attempts. In an embodiment, the method communicates the log to network administration resources as well as to local users. In an embodiment, the method further logs scanning efforts which do not detect the synthetic data among the scanned resources, and which indicate that data is not being leaked.

In an embodiment, a user seeks to submit the data entry form after remediating issues identified in the provided alert and/or malicious activity reporting. In this embodiment, as or after the user re-submits the data entry form, the method detects the attempt to submit the sensitive data, captures the original data entry form, generates synthetic data, populates a second version of the data entry form, begins monitoring system memory and communications resources, submits the second version of the form including the synthetic non-sensitive data, and proceeds as described above, depending upon the outcome of the monitoring.

Concurrent with the generation of synthetic data, population of the data entry form with the synthetic data, and submission of the populated data entry form, the method begins monitoring system resources correlated with malicious data capture activities. Such resources include memory resources, network communications resources and network communications traffic contents, and processor command stacks. Resources may be checked in turn or prioritized according to relevant commands, such as write commands or transmit commands. After finding synthetic data string(s) through monitoring, the method evaluates the details of the detection relative to expected system activity. As an example, sending a password as part of a user authentication process has an expected data handling progression associated with it. The entered data follows a defined pathway associated with authentication, such as a forked web browser containing the data entry field. The detection of the synthetic data in locations outside the communications channels and memory locations associated with the known and defined data pathways of the authentication application, triggers an alert associating the detected synthetic data with malicious activity. Scanning continues until all resources are scanned or until the scanning duration reaches a defined scanning time limit.

In an embodiment, the method scans network stack resources. For example, the method scans buffers and/or packets being transmitted after submission of the second form including the synthetic data. In an embodiment, the method monitors data transmitted over the network by the local system after submitting the form.

Detection of the synthetic string(s) in buffers, packets, or otherwise, among the network data traffic triggers alerting, reporting and logging functionality as described above. In an embodiment, the method validates detected transmission of synthetic data against transmission expectations associated with the relevant authentication application. Deviations from expected transmissions for the data trigger the alerting, reporting, and logging functionalities. Detected data leaks further trigger sub-processes to collect relevant information regarding the detected synthetic string, the associated application and data dumps initiated and including the synthetic string(s).

Disclosed embodiments may be configured to detect user password entry as well as the entry of other sensitive information such as user personally identifying information data, or finance data such as user financial account data. Disclosed embodiments may be integrated with password management applications to better define expected data handling of password data after submission, preventing false triggering of alerts for mishandling the data.

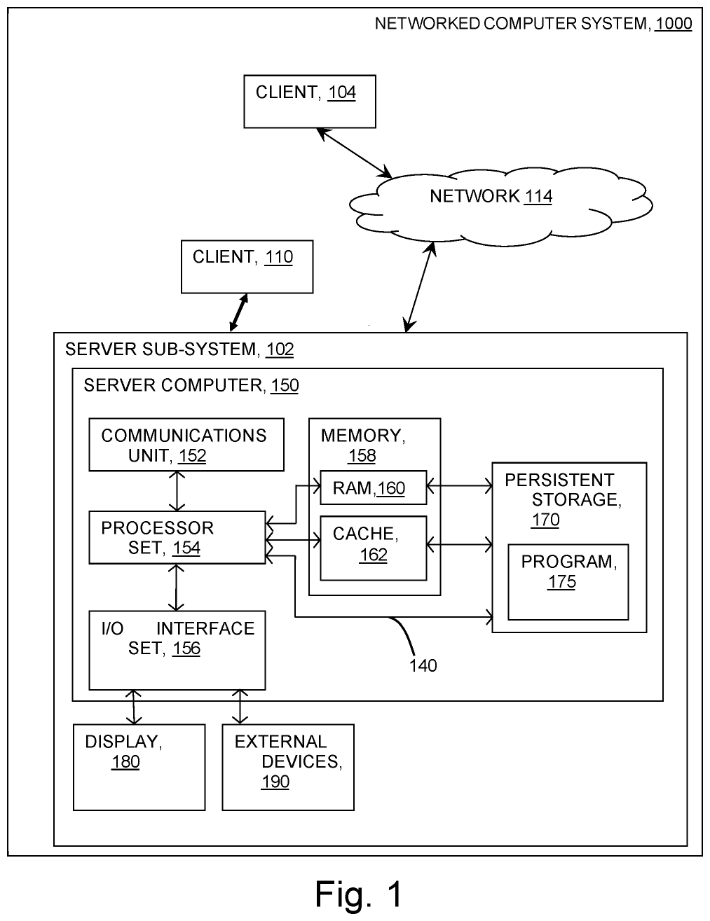

FIG. 1 provides a schematic illustration of exemplary network resources associated with practicing the disclosed inventions. The inventions may be practiced in the processors of any of the disclosed elements which process an instruction stream. As shown in the figure, a networked Client device 110 connects wirelessly to server sub-system 102. Client device 104 connects wirelessly to server sub-system 102 via network 114. Client devices 104 and 110 comprise data leak detection program (not shown) together with sufficient computing resource (processor, memory, network communications hardware) to execute the program. Client devices 104 and 110 provide user access to data leak detection program which may rub locally on these devices as a user interacts with additional networked resources depicted in the figure. As shown in FIG. 1, server sub-system 102 comprises a server computer 150. FIG. 1 depicts a block diagram of components of server computer 150 within a networked computer system 1000, in accordance with an embodiment of the present invention. It should be appreciated that FIG. 1 provides only an illustration of one implementation and does not imply any limitations with regard to the environments in which different embodiments can be implemented. Many modifications to the depicted environment can be made.

Server computer 150 can include processor(s) 154, memory 158, persistent storage 170, communications unit 152, input/output (I/O) interface(s) 156 and communications fabric 140. Communications fabric 140 provides communications between cache 162, memory 158, persistent storage 170, communications unit 152, and input/output (I/O) interface(s) 156. Communications fabric 140 can be implemented with any architecture designed for passing data and/or control information between processors (such as microprocessors, communications and network processors, etc.), system memory, peripheral devices, and any other hardware components within a system. For example, communications fabric 140 can be implemented with one or more buses.

Memory 158 and persistent storage 170 are computer readable storage media. In this embodiment, memory 158 includes random access memory (RAM) 160. In general, memory 158 can include any suitable volatile or non-volatile computer readable storage media. Cache 162 is a fast memory that enhances the performance of processor(s) 154 by holding recently accessed data, and data near recently accessed data, from memory 158.

Program instructions and data used to practice embodiments of the present invention, e.g., the data leak detection program 175, are stored in persistent storage 170 for execution and/or access by one or more of the respective processor(s) 154 of server computer 150 via cache 162. In this embodiment, persistent storage 170 includes a magnetic hard disk drive. Alternatively, or in addition to a magnetic hard disk drive, persistent storage 170 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 170 may also be removable. For example, a removable hard drive may be used for persistent storage 170. Other examples include optical and magnetic disks, thumb drives, and smart cards that are inserted into a drive for transfer onto another computer readable storage medium that is also part of persistent storage 170.

Communications unit 152, in these examples, provides for communications with other data processing systems or devices, including resources of client computing devices 104, and 110. In these examples, communications unit 152 includes one or more network interface cards. Communications unit 152 may provide communications through the use of either or both physical and wireless communications links. Software distribution programs, and other programs and data used for implementation of the present invention, may be downloaded to persistent storage 170 of server computer 150 through communications unit 152.

I/O interface(s) 156 allows for input and output of data with other devices that may be connected to server computer 150. For example, I/O interface(s) 156 may provide a connection to external device(s) 190 such as a keyboard, a keypad, a touch screen, a microphone, a digital camera, and/or some other suitable input device. External device(s) 190 can also include portable computer readable storage media such as, for example, thumb drives, portable optical or magnetic disks, and memory cards. Software and data used to practice embodiments of the present invention, e.g., data leak detection program 175 on server computer 150, can be stored on such portable computer readable storage media and can be loaded onto persistent storage 170 via I/O interface(s) 156. I/O interface(s) 156 also connect to a display 180.

Display 180 provides a mechanism to display data to a user and may be, for example, a computer monitor. Display 180 can also function as a touch screen, such as a display of a tablet computer.

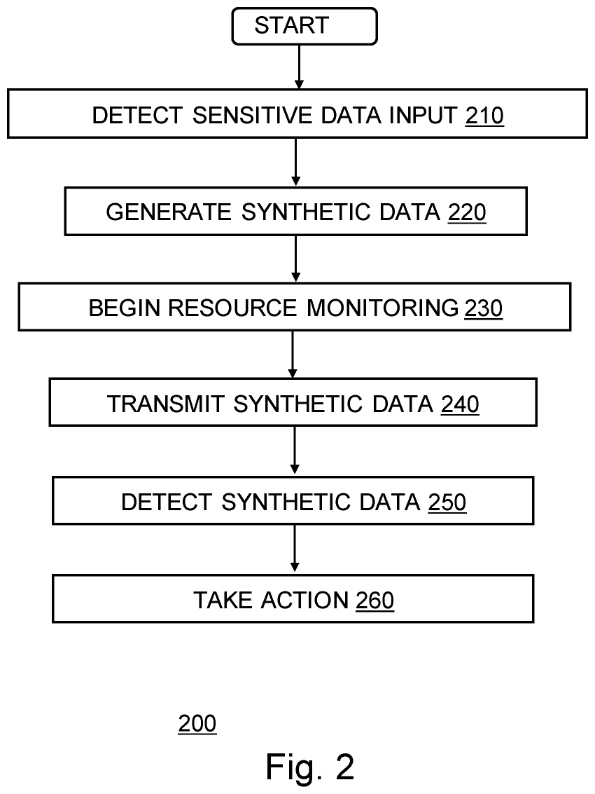

FIG. 2 provides a flowchart 200, illustrating exemplary activities associated with the practice of the disclosure. After program start, at block 210, data leak detection program 175, executing through a computer environment such as that depicted in FIG. 1, detects user input of sensitive information, such as user password information, through a first copy of a data entry form. In an embodiment, the method monitors user activities, enabling detection of such an attempted data input. In an embodiment, data leak detection program 175 runs as a shell program under an operating system monitoring user interactions with other executing applications.

At block 220, the method of data leak detection program 175 generates synthetic data corresponding to the user sensitive data and satisfying any requirements for the sensitive data. The method populates a second copy of the data entry form using the generated synthetic data. The method tracks the values of the generated synthetic data for use in scanning resources for leak detection.

At block 230, the method begins monitoring system resources, such as system processor commands, system memory contents, and network traffic contents for the presence of the synthetic data strings. At block 240, concurrent with the initiation of resource monitoring, the method transmits the second copy of the data entry form including the synthetic data.

At block 250, the method of the data leak detection program 175, determines if the synthetic data is present among the monitored resources such as system processor commands, memory resources, and network traffic. The method scans the resources seeking data matching the generated synthetic data strings. In an embodiment, scanning continues until all the method completes the scanning of all relevant resources, or until a predefined scan duration has been completed.

At block 260, the method takes appropriate action based upon detecting the presence of the generated synthetic data string(s) among scanned resources. For example, the method evaluates the detected synthetic data against expected activities for the data entered through the form. The method notes expected applications and network traffic associated with the legitimate use of the entered data without triggering alerts of malicious activity. For data activities outside the expected activities, the method captures details regarding the activities, such as the relevant application(s) and the nature of network traffic—sender and recipient, for inclusion in alerts and activity logs for the user and/or system administrator.

For instances where the method fails to detect the synthetic data after scanning all relevant resources or scanning for the defined scan duration, the method submits the saved original copy of the data entry form, including the sensitive information entered by the user. In such instances, the method optionally further updates an event log indicating the occurrence of the san without detecting the synthetic data.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

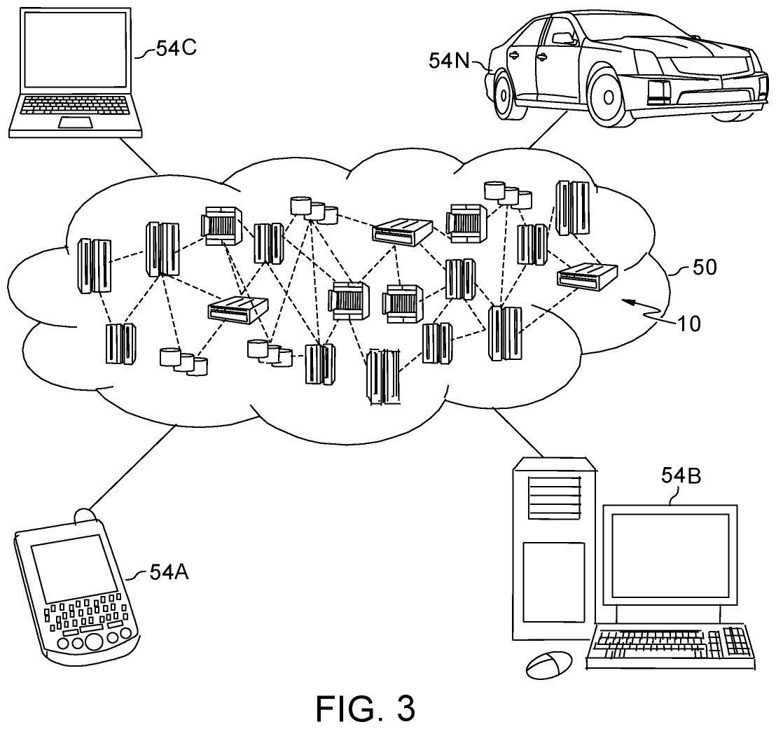

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

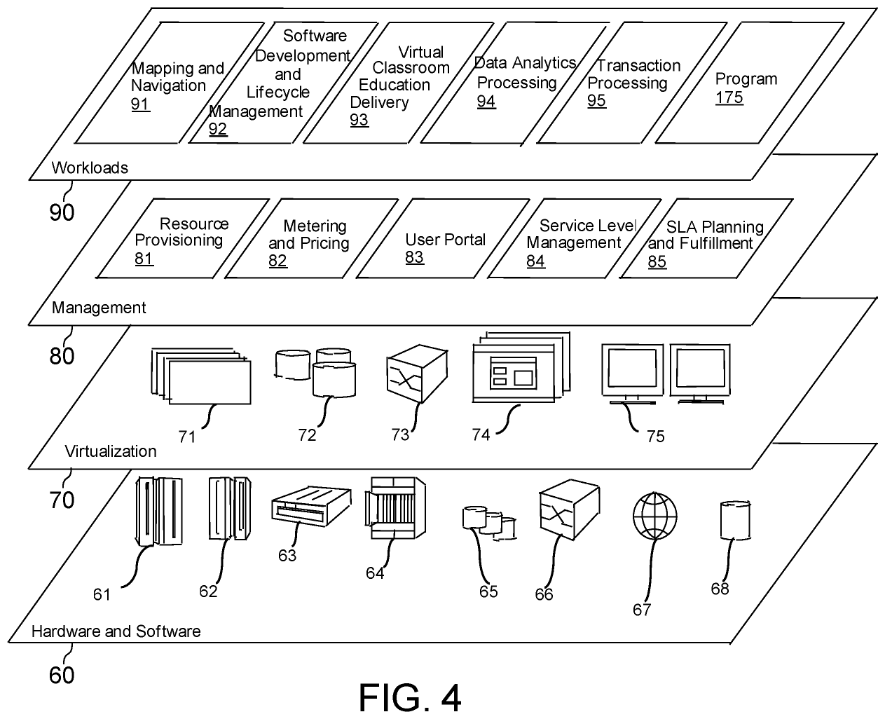

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data leak detection program 175.

The present invention may be a system, a method, and/or a computer program product at any possible technical detail level of integration. The invention may be beneficially practiced in any system, single or parallel, which processes an instruction stream. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, or computer readable storage device, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for detecting a data leak, the method comprising:
detecting, by one or more computer processors, user input in a first form, the user input satisfying a set of requirements;
storing, by the one or more computer processors, the user input in a memory;
generating, by the one or more computer processors, a synthetic input satisfying the set of requirements;
transmitting, by the one or more computer processors, a second form including the synthetic input;
searching, by the one or more computer processors, resources for the synthetic input;
determining, by the one or more computer processors, if the synthetic input is present among the resources according to the search; and
acting, by the one or more computer processors, upon the determination.

2. The computer implemented method according to claim 1, wherein the resources include resources selected from the group consisting of system memory resources, network communication resources, and combinations thereof.

3. The computer implemented method according to claim 1, wherein the set of requirements relate to user password requirements.

4. The computer implemented method according to claim 1, further comprising:
detecting, by the one or more computer processors, the synthetic input among the resources; and
generating, by the one or more computer processors, an alert associated with the synthetic input among the resources.

5. The computer implemented method according to claim 4, wherein the user input comprises a user password, and further comprising stopping a user authentication process.

6. The computer implemented method according to claim 1, further comprising:
failing, by the one or more computer processors, to detect the synthetic input among the resources; and
sending, by the one or more computer processors, the first form including the user input.

7. The computer implemented method according to claim 1, wherein searching resources comprises searching memory resources subject to a write command subsequent to sending the first form including the synthetic input.

8. A computer program product for detecting a data leak, the computer program product comprising one or more computer readable storage devices and collectively stored program instructions on the one or more computer readable storage devices, the stored program instructions comprising:
program instructions to detect user input in a first form, the user input satisfying a set of requirements;
program instructions to store the user input in a memory;
program instructions to generate a synthetic input satisfying the set of requirements;
program instructions to transmit a second form including the synthetic input;
program instructions to search resources for the synthetic input;
program instructions to determine if the synthetic input is present among the resources according to the search; and
program instructions to act upon the determination.

9. The computer program product according to claim 8, wherein the resources include resources selected from the group consisting of system memory resources, network communication resources, and combinations thereof.

10. The computer program product according to claim 8, wherein the set of requirements relate to user password requirements.

11. The computer program product according to claim 8, the stored program instructions further comprising:
program instructions to detect the synthetic input among the resources; and
program instructions to generate an alert associated with the synthetic input among the resources.

12. The computer program product according to claim 11, wherein the user input comprises a user password, and further comprising stopping a user authentication process.

13. The computer program product according to claim 8, the stored program instructions further comprising:
program instructions to send the first form including the user input after failing to detect the synthetic input among the resources.

14. The computer program product according to claim 8, wherein searching resources comprises searching memory resources subject to a write command subsequent to sending the first form including the synthetic input.

15. A computer system for detecting a data leak, the computer system comprising:
one or more computer processors;
one or more computer readable storage devices; and
stored program instructions on the one or more computer readable storage devices for execution by the one or more computer processors, the stored program instructions comprising:
program instructions to detect user input in a first form, the user input satisfying a set of requirements;
program instructions to store the user input in a memory;
program instructions to generate a synthetic input satisfying the set of requirements;
program instructions to transmit a second form including the synthetic input;
program instructions to search resources for the synthetic input;
program instructions to determine if the synthetic input is present among the resources according to the search; and
program instructions to act upon the determination.

16. The computer system according to claim 15, wherein the resources include resources selected from the group consisting of system memory resources, network communication resources, and combinations thereof.

17. The computer system according to claim 15, wherein the set of requirements relate to user password requirements.

18. The computer system according to claim 15, the stored program instructions further comprising:
program instructions to detect the synthetic input among the resources; and
program instructions to generate an alert associated with the synthetic input among the resources.

19. The computer system according to claim 18, wherein the user input comprises a user password, and further comprising stopping a user authentication process.

20. The computer system according to claim 15, the stored program instructions further comprising:
program instructions to send the first form including the user input after failing to detect the synthetic input among the resources.
